(19) United States
(12) Patent Application Publication
(10) Pub. No.: US 2010/0229522 A1
(43) Pub. Date: Sep. 16, 2010

(54) Plasma-Assisted E-Waste Conversion Techniques

(76) Inventor: Jim Kingzett, Gardnerville, NV (US)

Correspondence Address: McDermott Will & Emery, 600 13th Street, NW, Washington, DC, 20005-3096, US

(21) Appl. No.: 12/725,410

(22) Filed: Mar. 16, 2010

Related U.S. Application Data
(60) Provisional application No. 61/160,456, filed on Mar. 16, 2009.

(51) Int. Cl. F02C 7/22

(52) U.S. Cl. 60/39.12

(57) ABSTRACT

Plasma-Based Waste-to-Energy (PBWTE) facility/systems, including plasma-assisted gasification systems, are described that can be integrated into a single system which when fed a steam of municipal solid waste, discarded tires, or electronic wastes, organic or inorganic, which have been shredded to a uniform size produces a synthesis gas (syngas) and a molten slag, and/or electricity.

This application claims priority to U.S. Provisional Patent Application No. 61/160,456, filed 16 Mar. 2009, and entitled “Plasma-Assisted E-Waste Conversion Techniques,” the entire contents of which are incorporated herein by reference.

Existing techniques that translate synchronous gate-level circuits into asynchronous counterparts do not adequately support gated clocks and consequently can incur unnecessary switching activity. The invention addresses this limitation by

Plasma-based waste-to-energy systems/methods according to the present disclosure can be composed of several components (which may be/are currently commercially available) and operating in various forms and functions, e.g., as will be described.

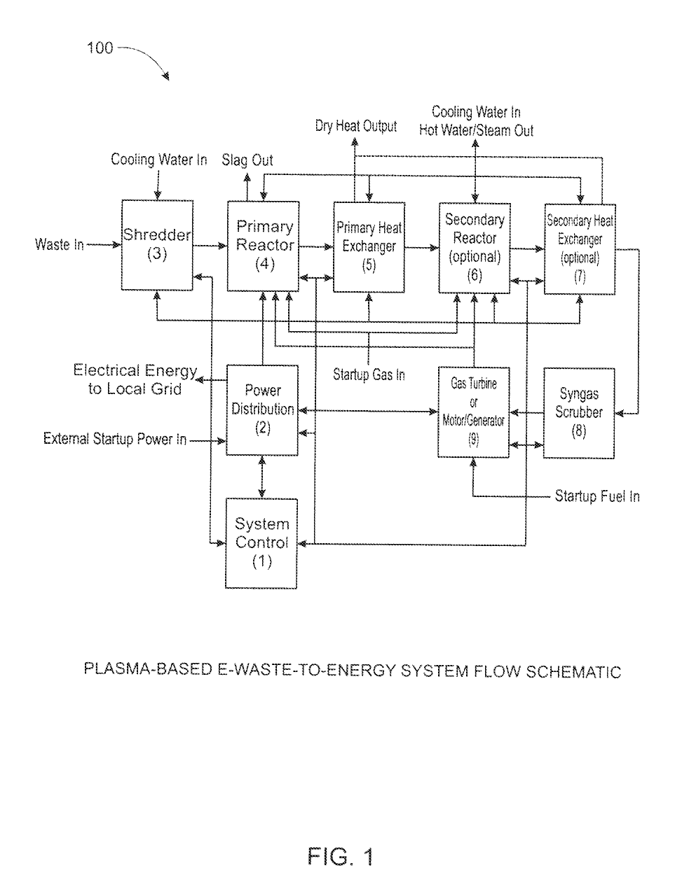

FIG. 1 depicts a box diagram representing a system/method 100 in accordance with exemplary embodiments of the present disclosure.

As shown in FIG. 1, in a Plasma-Based Waste-to-Energy (PBWTE) facility/system 100 according to the present disclosure, these components are integrated into a single system which when fed a steam of municipal solid waste, discarded tires, or electronic wastes, organic or inorganic, which have been shredded, e.g., ideally to a uniform size (3), produces a synthesis gas (syngas) and a molten slag (4), and/or electricity. In the plasma arc phase (4) (6) the wastes are broken down by intense heat, e.g., 8,000 to 15,000° C., through atomic dissociation thus passing from the solid to the gas phase. The speed of this reaction is such that no toxic dioxins or furans are formed. System 100 (and other according to the present disclosure) can utilize suitable plasma-assisted gasification techniques, e.g., as described herein and/or described in U.S. Patent Application Publication No. US 2003/0171635, published 11 Sep. 2003, and entitled “Method for Treatment of Hazardous Fluid Organic Waste Materials,” the entire contents of which are incorporated herein by reference.

Continuing with the description of FIG. 1, syngas can then cooled through heat exchangers (5) (7) which produce steam (4) (5) (6) (7). The steam can then be used to power steam turbine-driven electrical generators (not shown). Once cooled, the syngas passes through a gas scrubber to remove particulate matter. The syngas may them be used as a fuel to power gas turbine-driven electrical generators (9) or an internal combustion engine which powers a generator (9). Exhaust gasses from either the turbine or internal combustion engine are returned to either the primary (4) or secondary (6) reaction chamber where they are reprocessed and added to the generated syngas.

In exemplary embodiments, from 10 to 35% of the electrical energy generated (9) is used to run the PBWTE system and the remaining electrical energy may be sold to local power companies (2). In most developed nations, power companies must purchase all electrical energy produced by environmentally friendly means and they must pay a minimum price equal to or greater than the current local wholesale price per kilowatt hour. Depending on waste composition, each ton of waste can, or may be expected to, produce approximately one megawatt of electrical energy. Other outputs may of course be realized.

NOTE: Although not shown in FIG. 1, an alternate process (or processes) may be used where the syngas is fed into a series of bioreactors that contain trays of genetically engineered microbes which convert the incoming gas to either ethanol or acetic acid or a combination of both, depending on the selection of microbes.

With continued reference to FIG. 1, the bioreactor process also produces carbon dioxide (CO₂) as an off-gas. This CO₂ is fed back into the reaction chamber (4) (6) to prevent the formation of nitric oxides (N₂0), and any remaining CO₂, may be captured and fed into algae beds as a growth stimulant where the algae is being commercially produced as a base for BioFuels, or may be compressed to form dry ice and sold to transportation companies. H2 can be produced as a component of the syngas, and such may be used as desired, e.g., for a H2 distribution network for automobiles.

Should one elect to produce acetic acid, about one half ton of glacial-grade acetic acid will be produced. If the production of ethanol is the choice, about 128 gallons will be produced from one ton of waste, again, this is dependant on the type of waste processed. The ethanol may be sold as a motor-fuel additive or it may be retained and used as a fuel for gas-turbine or internal combustion powered electrical generators.

Virtually every pound of waste entering the system produces a saleable product in one form or another. Even the inorganic material forms a vitrified slag which exits at the bottom of the primary reaction chamber (4), may be sold as a high quality, nonleachable, construction material. No pollutants, either solid or gas, leave the system as air or surface releases.

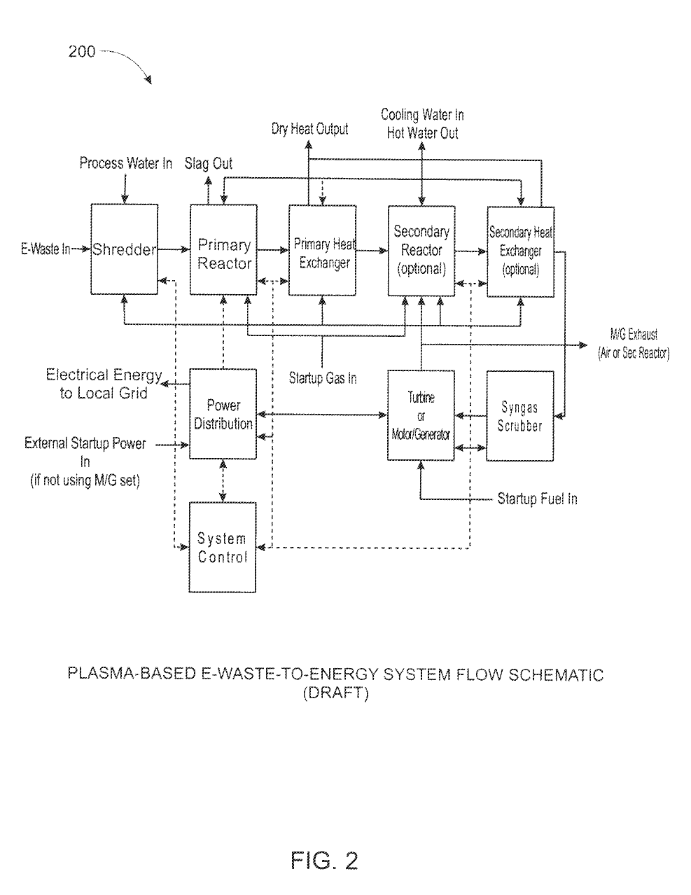

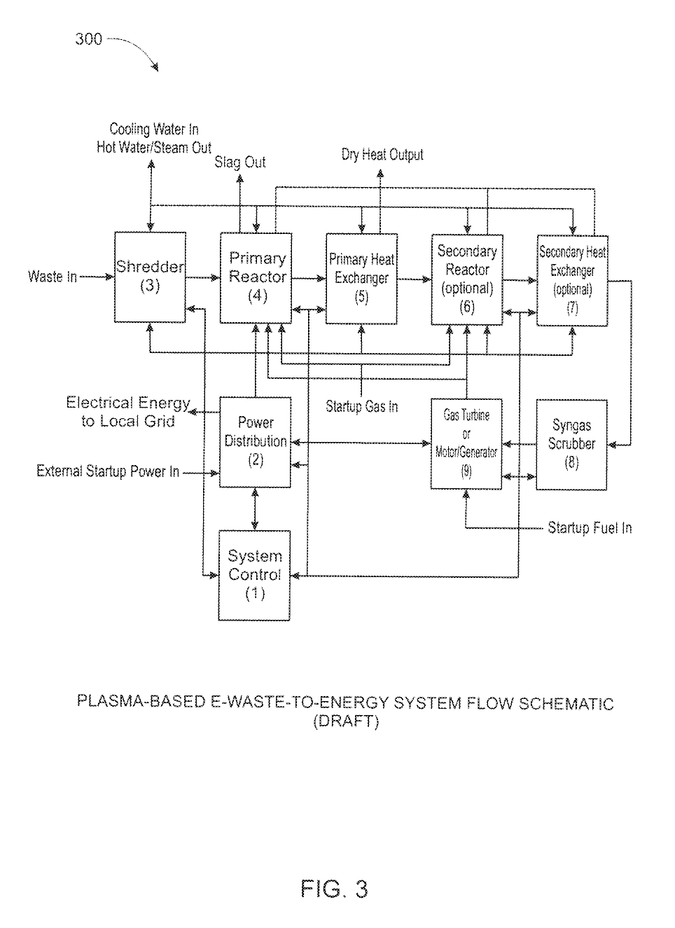

FIG. 2 depicts a box diagram representing a system/method 200 in accordance with alternate embodiments of the present disclosure. FIG. 3 depicts another embodiment 300 of the present disclosure.

### APPLICATIONS TO DATA CENTERS

As shown in FIGS. 1-3, an output of electricity may be produced by the systems/methods 100, 200, and 300. Such can be used as desired. In exemplary embodiments, system/methods 100, 200, and/or 300 are employed at the site of a data center (“DC”) (or other infrastructure requiring energy) for power. Accordingly, the carbon footprint of the DC (and/or other infrastructure, including a community) can be minimized or put to zero by implementation of embodiments of the present disclosure.

Because a PAG system may be located close to or at a DC, such a PAG system may be economically superior/advantageous to other power sources. Distributed Generation seems to be the way things are going so energy sales prices will start varying based on the type facility, the facility cost, the feed stock, the tipping fees, and the operation cost. PAG systems according to the present disclosure will certainly be less than that from a coal fired power plant as the PAG plant efficiency is much higher.

Optimally a PAG system will get many times more energy from 500 tons of e-waste than a coal fired plant gets from 5,000 tons of coal. A PAG system that burns only coal is several hundred percent more efficient that a boiler-based coal fired plant. It's for this reason that PAG systems according to the present disclosure can take both bed and fly ash, which have already been through a boiler system, and still extract a lot of energy from them with a PAG.

In exemplary embodiments, an e-waste PAG system can provide electrical energy and heat for powering air conditioning systems (160 degree water can produce 41 degree refrigerated air).

E-waste is generated in two basic process. First, the manufacturing of the items, and second the discarding and disposal of the finished product at the end of its lifecycle. In almost all manufacturing processes, the manufacturing generates the greater amount of waste. Formosa Plastics, at one time the world's largest supplier of electronic product cases and housings had a waste to finished product ration of 1.5:1. For every pound of finished product that went out the door, one and a half pounds of the same material went into a disposal bin. Recycling was, in most cases, more costly than starting from scratch. Much like recycling glass is today.

One skilled in the art will appreciate that embodiments and/or portions of embodiments of the present disclosure can be implemented in/with computer-readable storage media (e.g., hardware, software, firmware, or any combinations of such), and can be distributed and/or practiced over one or more networks.

Embodiments of the present disclosure can provide electricity or other energy (e.g., heat, warm water, etc.) off the local or regional/national electricity grid. Further, embodiments can include a portable plasma reactor on a vehicle for incineration at a facility, with simultaneous or subsequent transmission of resulting syngas and/or electricity.

Steps or operations (or portions of such) as described herein, including processing functions to derive, learn, or calculate formula and/or mathematical models utilized and/or produced by the embodiments of the present disclosure, can be processed by one or more suitable processors, e.g., central processing units (“CPUs) implementing suitable code/instructions in any suitable language (machine dependent on machine independent). Furthermore, embodiments of the present disclosure can be implemented as or include signals, e.g., wireless RF or infrared signals or electrical signals over a suitable medium such as optical fiber or conductive network.

While certain embodiments and/or aspects have been described herein, it will be understood by one skilled in the art that the methods, systems, and apparatus of the present disclosure may be embodied in other specific forms without departing from the spirit thereof. Accordingly, the embodiments described herein are to be considered in all respects as illustrative of the present disclosure and not restrictive.

What is claimed is:

1. A plasma assisted gassifation (PAG) system adapted for use with a data center, the system comprising:
a shredder;
a primary reactor configured to incinerate e-waster by application of plasma and producing syngas;
a primary heat exchanger;
a gas turbine for producing electricity from syngas;
a syngas scrubber; and
a system controller.

2. The system of claim 1, wherein the controller is programmed to control the electrical output of the gas turbine to match the needs of a data center electrically connected to the system.
